(19) United States
(12) Patent Application Publication
(10) Pub. No.: US 2026/0077316 A1
(43) Pub. Date: Mar. 19, 2026

(54) Microporous Hollow Fiber Webs and Methods of Making Same

(71) Applicant: 3M INNOVATIVE PROPERTIES COMPANY, St. Paul, MN (US)

(72) Inventors: Jinsheng Zhou, Woodbury, MN (US); Ronald W. Ausen, St. Paul, MN (US); William J. Kopecky, Hudson, WI (US)

(21) Appl. No.: 19/108,483

(22) PCT Filed: Sep. 27, 2023
(86) PCT No.: PCT/IB2023/059610

§ 371 Date: Mar. 4, 2025

Related U.S. Application Data
(60) Provisional application No. 63/422,125, filed on Nov. 3, 2022.

(51) Int. Cl. B01D 69/08; B01D 67/00; B01D 71/26

(52) U.S. Cl. CPC B01D 69/082; B01D 67/0027; B01D 69/0871; B01D 69/088; B01D 71/262; B01D 2323/60; B01D 2325/0281

(57) ABSTRACT

The present disclosure provides microporous hollow fiber webs, including connected hollow fibers. At least some of the hollow fibers have an open celled porous structure including microfibrils that connect lamellae microstructures. Methods of making microporous hollow fiber webs are also provided. Such methods include obtaining a hollow fiber web having connected hollow fibers, and stretching the hollow fiber web in a machine direction to fracture at least a portion of the hollow fibers to generate an open celled porous structure.

### BACKGROUND

Webs of connected hollow strands have been formed, such by using extrusion methods. Such webs lack porosity, however.

### SUMMARY

In a first aspect, a microporous hollow fiber web is provided. The microporous hollow fiber web comprises a plurality of connected hollow fibers. At least some of the hollow fibers comprise an open celled porous structure comprising microfibrils that connect lamellae microstructures.

In a second aspect, a method of making a microporous hollow fiber web is provided. The method comprises obtaining a hollow fiber web comprising a plurality of connected hollow fibers; and stretching the hollow fiber web in a machine direction to fracture at least a portion of the hollow fibers to generate an open celled porous structure comprising microfibrils that connect lamellae microstructures in the fractured hollow fibers.

At least certain embodiments of the present disclosure provide a simplified process to prepare a microporous hollow fiber web by stretching a hollow fiber web to form an open celled porous structure including microfibrils that connect lamellae microstructures. Hollow fiber webs may be produced by extrusion processes such as those described in PCT Publication Nos. WO 2020/170115, WO 2021/028798, and WO 2021/250478 (each to Ausen et al.). Stretching is then applied to the hollow fiber web. Unexpectedly, good fiber porosity has been achieved by such a process, which has the potential to significantly reduce costs of manufacturing microporous hollow fiber webs. For instance, in an alternative method of forming a microporous hollow fiber web, a typical air-laid process would require several more total steps: extruding hollow fibers, stretching the hollow fibers to form pores, and knitting individual porous hollow fibers together to form a web. Porous hollow fiber webs may be useful in filtration or other separation applications, for example.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1 is a schematic perspective cross-sectional view of connected hollow fibers in which adjacent hollow fibers are connected at bond regions.

FIG. 2 is a schematic perspective cross-sectional view of connected hollow fibers in the form of discrete hollow fibers with spacer segments between adjacent hollow fibers.

FIG. 3 is a schematic perspective cross-sectional view of connected hollow fibers in the form of discrete hollow fibers with spacer segments between adjacent hollow fibers, in which the hollow fibers are within two planes.

FIG. 4 is a schematic perspective cross-sectional view of connected hollow fibers in the form of a netting in which polymeric strands are periodically joined together at bond regions throughout an array with spaces between adjacent strands and at least a portion of the strands are the connected hollow fibers each in a form of a hollow polymeric strand.

FIG. 5 is scanning electron microscopy (SEM) image of a portion of an exemplary hollow fiber web.

FIG. 6A is an SEM image of a cross-section of a portion of an exemplary microporous hollow fiber web.

FIG. 6B is an SEM image of a portion of a hollow fiber of the exemplary microporous hollow fiber web of FIG. 6A.

FIG. 6C is an SEM image of a portion of a segment between two hollow fibers of the exemplary microporous hollow fiber web of FIG. 6A.

FIG. 6D is an SEM image of a portion of an exemplary microporous hollow fiber showing microfibrils that connect lamellae microstructures.

FIG. 6E is an SEM image of a portion of an exemplary microporous hollow fiber showing the open celled porous structure of an interior surface of the hollow fiber.

FIG. 7 is a photograph of an exemplary microporous hollow fiber web subjected to a gas flux experiment.

While the above-identified figures set forth several embodiments of the disclosure other embodiments are also contemplated, as noted in the description. The figures are not necessarily drawn to scale. In all cases, this disclosure presents the invention by way of representation and not limitation.

### DETAILED DESCRIPTION OF ILLUSTRATIVE EMBODIMENTS

As used herein, the term “fracture” with respect to a hollow fiber means to generate a void in a portion of the polymeric material of the hollow fiber.

As used herein, the term “open celled porous structure” with respect to a hollow fiber's structure refers to a hollow fiber that has a plurality of pores, at least some of which are connected to adjacent pores such that a fluid can pass from one major surface of a portion of the hollow fiber to an opposing major surface.

As used herein, the term “microfibril” refers to a portion of a porous structure of a hollow fiber having a fibril in which each dimension is less than 1 micrometer in size.

As used herein, the term “lamellae” refer to crystal portions of semicrystalline polymeric material of a hollow fiber.

As used herein, the term “continuous” with respect to a hollow fiber refers to a hollow fiber having a longest dimension that has a length of greater than 1 centimeter.

As used herein, the term “web” with respect to a hollow fiber web refers to an array or network of integrally attached hollow fibers (e.g., by co-extrusion as opposed to using another material as with individual hollow fibers that are knit together). A web encompasses strips and ribbons having a substantially longer length in one planar axis than the other, as well as webs having similar lengths in both planar axes.

As used herein, the term “netting” refers to a web that includes openings (e.g., spaces) between portions of adjacent fibers.

As used herein, the term “amorphous” refers to a polymer that does not exhibit a melting point.

As used herein, the term “semicrystalline” refers to a polymer that beside an amorphous phase forms crystalline domains during solidification, plus exhibits a melting peak during heating and a crystallization peak during solidification as measured by dynamic scanning calorimetry (DSC).

As used herein, the term “porosity” refers to a measurement of void spaces in a fiber that has an open celled porous structure, as determined by gas flux measurement. One gas flux method is described in detail in the Examples below.

As used herein, “filler” refers to a solid particulate included in a fiber-forming material.

As used herein, “solid” with respect to a particulate refers to the state of matter that is stable in shape, as opposed to a state of matter that is liquid or gas.

As used herein, “thermoplastic” refers to a polymer that flows when heated sufficiently above its glass transition point and become solid when cooled. In contrast, “thermoset” refers to a polymer that permanently sets upon curing and does not flow upon subsequent heating. Thermoset polymers are typically crosslinked polymers.

As used herein, the term “glass transition temperature” (T_{g}), of a polymer refers to the transition of a polymer from a glassy state to a rubbery state and can be measured using Differential Scanning calorimetry (DSC), such as at a heating rate of 10° C. per minute in a nitrogen stream. When the T_{g} of a monomer is mentioned, it is the T_{g} of a homopolymer of that monomer. The homopolymer must be sufficiently high molecular weight such that the T_{g} reaches a limiting value, as it is generally appreciated that a T_{g} of a homopolymer will increase with increasing molecular weight to a limiting value. The homopolymer is also understood to be substantially free of moisture, residual monomer, solvents, and other contaminants that may affect the T_{g}. A suitable DSC method and mode of analysis is as described in Matsumoto, A. et. al., J. Polym. Sci. A., Polym. Chem. 1993, 31, 2531-2539.

As used herein, “machine direction” (MD) as used herein denotes the direction of a running web of material during a manufacturing process. The terms “machine direction” and “longitudinal direction” may be used interchangeably. The term “transverse direction” (TD) as used herein denotes the direction which is essentially perpendicular to the machine direction.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

In a first aspect, a microporous hollow fiber web is provided. The microporous hollow fiber web comprises:
a plurality of connected hollow fibers, wherein at least some of the hollow fibers comprise an open celled porous structure comprising microfibrils that connect lamellae microstructures.

In a second aspect, a method of making a microporous hollow fiber web is provided. The method comprises:
obtaining a hollow fiber web comprising a plurality of connected hollow fibers; and
stretching the hollow fiber web in a machine direction to fracture at least a portion of the hollow fibers to generate an open celled porous structure comprising microfibrils that connect lamellae microstructures in the fractured hollow fibers.

The below disclosure relates to both the first and second aspects.

Polymeric materials are employed to form continuous hollow fibers of the hollow fiber web. Often, the hollow fibers comprise one or more semicrystalline polymers. Suitable materials for the continuous fibers include for instance and without limitation, at least one of a polypropylene (PP), a polyethylene (PE), a polymethyl pentene (PMP), polybutene-1, a polyoxymethylene (POM), or copolymers thereof. Optionally, the continuous fibers include a blend of at least two polymers, e.g., a blend of a first PP and a second PP. In some cases, one PP is preferred or two or more (e.g., different) PPs are preferred. For instance, the continuous fibers may comprise a PP having a number average molecular weight (Mn) of 250,000 grams per mole (g/mol) or greater, 275,000 g/mol, 300,000 g/mol, 325,000 g/mol, 350,000 g/mol, 375,000 g/mol, or 400,000 g/mol or greater; and 800,000 g/mol or less, 775,000 g/mol, 750,000 g/mol, 725,000 g/mol, 700,000 g/mol, 675,000 g/mol, 650,000 g/mol, 625,000 g/mol, 600,000 g/mol, 575,000 g/mol, 550,000 g/mol, 525,000 g/mol, 500,000 g/mol, 475,000 g/mol, 450,000 g/mol, or 425,000 g/mol or less. The continuous fibers may comprise a PP having a number average molecular weight of 250,000 g/mol to 800,000 g/mol, inclusive. The number average molecular weight can be determined using Gel Permeation Chromatography. Exemplary PPs include for instance those polypropylenes commercially available under the trade designation “PPH3264” and “PPH3766” both from TotalEnergies Petrochemicals & Refining USA, Inc. (Houston, TX).

Suitable crystalline thermoplastic polypropylene homopolymer resins are available from TotalEnergies Petrochemicals & Refining USA, Inc. (Houston, TX) such as, for example Homopolymer Polypropylene 3281, 3274, PPH3060, 3273, 3272, 3371, PPH4022, PPH4069, 3462, 3571, 3662. M3661, 3766, 3865, 3860. Other suitable polypropylene homopolymers are available from Lyondel-Basell Industries (Pasadena, TX) under the trade designation PRO-FAX such as, for example, PRO-FAX 1280 PRO-FAX 814, PRO-FAX 1282, PROFAX 1283 or under other trade designation such as ADFLUEX X500F, ADSYL 3C30F. HP403G, TOPPYL SP 2103. Additional suitable polypropylene homopolymers are available from INEOS Olefins & Polymers, USA (Carson, CA), for example INEOS H01-00, INEOS H02C-00, INEOS H04G-00, and INEOS H12G-00. Other suitable polypropylene homopolymers are available from Braskem Chemical and Plastics Company (LaPorte, TX), for example, F008, F013M, FF026, FF030F2. Further suitable polypropylene homopolymers are available from Exxon-Mobil Chemical Co. (Spring, TX), for example, pp 1024E4, pp 2252E3, pp 4292E1, and pp 4612E2, pp 4792,

Suitable crystalline thermoplastic polyethylene (PE) homopolymer resins are available from Exxon-Mobil Chemical Co. Spring, TX), for example, HDPE 6908. Suitable polyethylene homopolymers are also available from TotalEnergies Petrochemicals& Refining USA, Inc. (Houston, TX), for example, High density polyethylene HDPE 56020, HDPE 55060, HDPE 5802. HDPE 51090, HDPE 5502. Other suitable polyethylene homopolymers are available from Braskem Chemical and Plastics Company (LaPorte, TX), for example, HF0144, HF0150, HF0147, and FH35; polyethylene polymer from NOVA Chemicals Corporation (Calgary, AB, Canada), for example, SUPRASS HPs167-AB, HPs267-AB, HPs667-AB, SCLAIR 19E, SCLAIR99L. NOVAPOL HB-L354-A.

In some embodiments, the resin can also include one or more poly(methyl)pentene (PMP) copolymer resins. Suitable grades of PMP copolymer resin having a low content of linear or branched alpha olefin comonomers are available from Mitsui Chemical (Minato-Ku, Tokyo, Japan) under the general trade designation TPX, for example resin grades DX470, RT18, DX820, and DX845.

Suitable crystalline thermoplastic polybutene-1 (PB-1) homopolymer resins are available from Lyondel-Basell Industries (Pasadena, TX) for example Toppyl PB 0110M. Toppyl PB 8640M, Toppyl PB 8310, Toppyl PB 8340M.

In some embodiments, the polymeric material comprises a filler material (e.g., aluminum oxide, aluminum nitride, aluminum trihydrate, boron nitride, aluminum, copper, graphite, graphene, magnesium oxide, zinc oxide) to provide thermal conductivity to the hollow fiber web.

In some cases, the microporous hollow fiber web includes a continuous web of an array of the connected hollow fibers each in a form of a discrete hollow fiber, in which adjacent hollow fibers are connected at bond regions. Referring to FIG. 1, such a suitable hollow fiber web 100 comprises an array of discrete hollow fibers 102. The hollow fibers 102 can have hollow fiber a hollow core 116 with a sheath 114 surrounding the hollow core. In some embodiments, the hollow cross-sectional area of the fibers with hollow cross-sectional area is greater than 50%, 60%, 70% or 80% of the area between the top and bottom surface of the web. Adjacent hollow fibers 102 are connected at bond regions 118. The length L of bond regions 118 is more than 5% of the average diameter of hollow fibers 102.

In general, the length L of the bond region creates a more rectilinear tubular opening of adjacent connected hollow fibers when the bond length is longer. Rectilinear shapes with round corners, such as squircles, result in hollow cross-sectional areas which have a greater portion of the area between the top and bottom surface of the web as compared to circular shapes which are bonded together at only a tangent point. Short bond lengths L create tubular shapes which are more oval in shape. These squircle shapes can also be extruded onto flat quench surfaces to create flat top or bottom segments of the squircle shape. Rectilinear shaped squircles enable larger contact area to the top and bottom planar surfaces than that of circular shaped hollow fibers. This larger contact area can be useful for heat transport between the top or bottom surface, for instance. In some embodiments, the bond region has a length L of a range from 0.1 millimeters (mm) to 5 mm. In some embodiments, the thickness T2 of the bond region is substantially uniform along its length. As shown in exemplary web 100 of FIG. 1, the cross-section of hollow fibers 102 have the same shapes. In some other embodiments, the cross-section of hollow fibers 102 can have different shapes. The cross-section of hollow fibers 102 can be any suitable shape, for example, a squircle, a circle, or an oval. The hollow fibers 102 typically have a (e.g., tube) wall thickness T1 in a range from 0.025 to 0.25 mm. Adjacent hollow fibers have a first bond point 120 and second bond point 121, and the bond point has a radius more than 0.1 T1, 0.2 T1, 0.3 T1, 0.4 T1, or 0.5 T1. These bond points represent the beginning and ending of the bond region between adjacent hollow fibers. As such, they are the beginning point and the end point of the bond line shown as length L in FIG. 1. The bond point with the adjacent hollow fiber walls, creates the radius at the ends of the bond length. Bond points with radiuses provide crack propagation resistance between hollow fibers. In some embodiments the strength of the bond or weld between hollow fibers is greater than the strength of the wall T1. As shown in FIG. 1, the web 100 can be a continuous web. As shown in the hollow fiber web 100 of FIG. 1, hollow fibers 102 are within the same plane. FIG. 1 shows individual hollow fiber width W1 and individual hollow fiber height H1. Squircle shaped hollow fibers have flat surfaces on the top and bottom surface of the web. Dimension W2 and dimension t shown in FIG. 1 can be used to determine contact area of squircle shaped tubular webs. Surface contact area as a percentage can be calculated by comparison of dimension W1 vs W2, shown in FIG. 1.

In some embodiments the contact area of the top and bottom surface of a squircle shaped web can be up to 10%, up to 25%, 50% or even up to 95% of the top or bottom planar surface area.

In some embodiments, webs described herein have a height H1 up to 5,000 micrometers (in some embodiments, up to, 2,000, 1,000, 500, or even up to 100; in a range from 100 to 5,000, 100 to 2,000, 100 to 1,000, or even 100 to 500) micrometers.

In some embodiments, the hollow fibers have an average cross-sectional diameter in a range from 0.1 to 5 millimeters. In some embodiments the thickness T2 is twice the thickness T1. In some embodiments the thickness T1 is uniform around the perimeter of the hollow fiber. In some embodiments the thickness T1 is varied to assist in formation of desired tubular shapes.

In some embodiments, at least 25 percent by number (in some embodiments, at least 30, 35, 40, 45, 50, 55, 60, 65, 70, 75, 80, 85, 90, 95, or even 100 percent by number) hollow fibers each have a hollow cross-sectional area in a range from 0.1 to 10 square millimeters (mm²) (in some embodiments, in a range from 0.1 to 2, or even 0.1 to 5) mm².

In some embodiments, the array of hollow fibers exhibits at least one of circle-shaped, oval-shaped, or squircle-shaped cross-sectional openings.

In some embodiments, the hollow fibers have a down web direction, for example t direction as shown in FIG. 1 and a cross-web direction. The hollow fibers typically extend substantially in a down-web direction.

For example, such hollow fiber webs as depicted in FIG. 1 may be made by providing an extrusion die defining at least a first cavity, and a second cavity, and a dispensing surface. The dispensing surface has an array of alternating dispensing orifices and the extrusion die provides a first passageway extending from the first cavity to a first plurality of orifices. The extrusion die provides a second passageway extending from a second cavity to a second plurality of orifices and provides an open air passageway for the second cavity and the second dispensing orifices. The method includes dispensing first hollow fibers from the first dispensing orifices.

Additional information that may be useful in making and using hollow fibers described therein (e.g., as depicted in FIG. 1), when combined with the instant disclosure, can be found in WO 2020/003065 and WO 2021/250478 (both to Ausen et al.), the disclosures of which are incorporated herein by reference in their entireties.

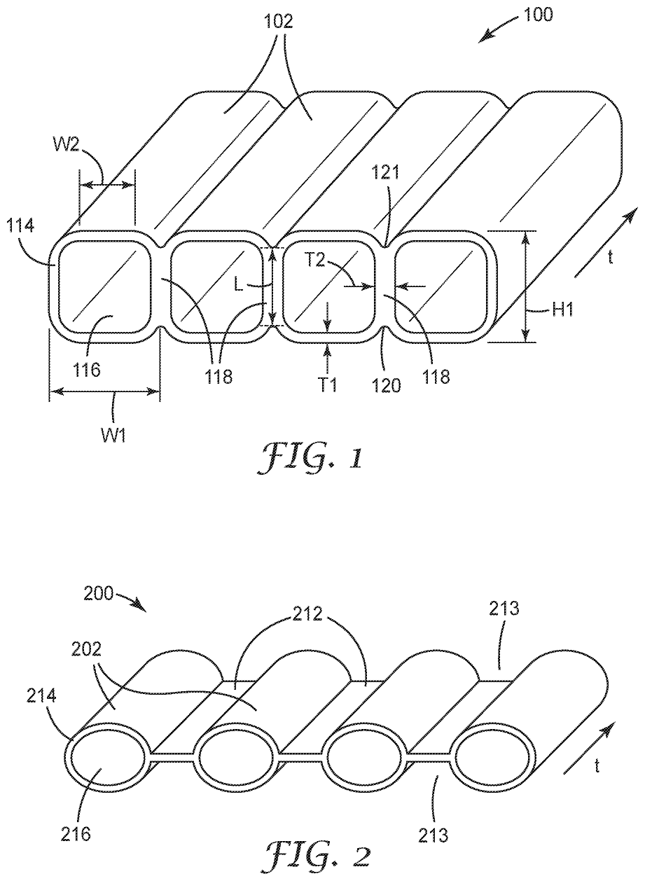

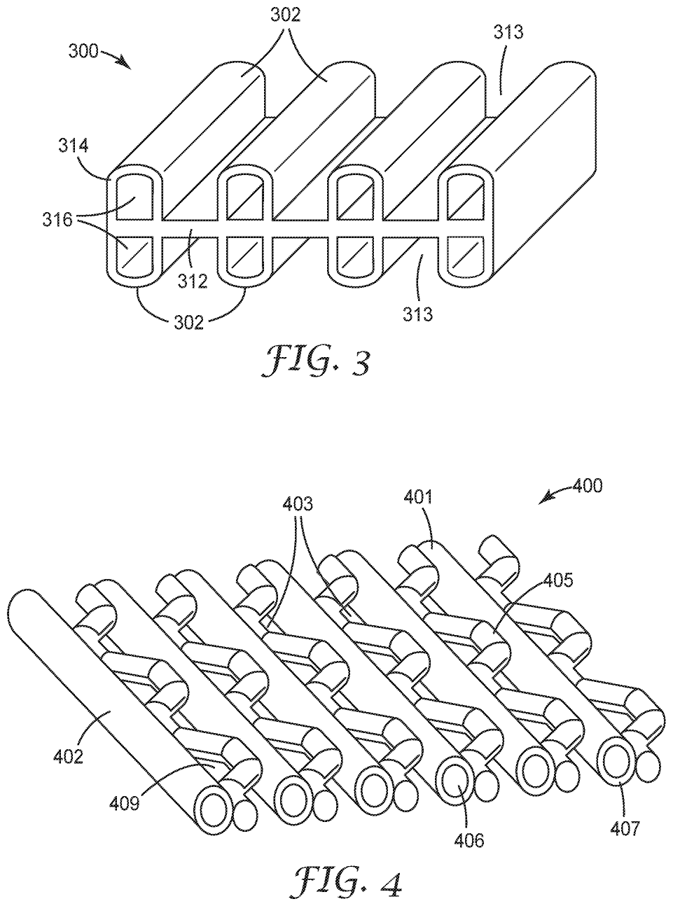

In some cases, the microporous hollow fiber web includes a continuous web of an array of the connected hollow fibers each in a form of a discrete hollow fiber and a plurality of spacer segments between at least a plurality of adjacent hollow fibers. Optionally, at least some of the spacer segments comprise an open celled porous structure. The hollow fibers are within one or more planes. For instance, FIG. 2 illustrates an embodiment in which the hollow fibers are within one plane, while FIG. 3 illustrates an embodiment in which the hollow fibers are within two planes.

Referring to FIG. 2, such a suitable hollow fiber web 200 comprises an array of discrete hollow fibers 202. Spacer segments 212 are located between adjacent hollow fibers 202. These spacer segments are formed at the same time as the hollow fibers and are welded together with the hollow fibers to form a continuous web. Spacer segments provide uniform arrangement and spacing of tubing. Areas 213 are formed between adjacent fibers. Hollow fibers 202 can have a hollow core 216 with a sheath 214 surrounding the hollow core. As shown in FIG. 2, the hollow fiber web 200 can be a continuous web. As shown in the hollow fiber web 200, the hollow fibers 202 are within the same plane.

Referring to FIG. 3, another suitable hollow fiber web 300 comprises an array of discrete hollow fibers 302. Spacer segments 312 are located between adjacent hollow fibers 302. These spacer segments are formed at the same time as the hollow fibers and are welded together with the hollow fibers to form a continuous web. The spacer segments provide uniform arrangement and spacing of hollow fibers. Areas 313 are formed between adjacent hollow fibers. Hollow fibers 302 can have a hollow core 316 with a sheath 314 surrounding the hollow core. As shown in FIG. 3, the hollow fiber web 300 can be a continuous web. As shown in the hollow fiber web 300, the hollow fibers 302 are within two planes (e.g., each on either side of the spacer segments). In some other embodiments, the hollow fibers 302 can be within more than two planes.

In some embodiments, hollow fiber webs described herein have a thickness up to 1000 micrometers (in some embodiments, up to, 500, 100, 50, or even up to 25: in a range from 10 to 750, 10 to 500, 10 to 100, 10 to 50, or even 10 to 25) micrometers. In some embodiments, the hollow fibers have an average (e.g., tube) wall thickness in a range from 5 to 100 micrometers. In some embodiments, the spacers have an average length in a range from 5 to 5000 micrometers.

In some embodiments, the hollow fibers have an average cross-sectional diameter in a range from 0.05 to 2 millimeters. In some embodiments, at least 25 (in some embodiments, at least 30, 35, 40, 45, 50, 55, 60, 65, 70, 75, 80, 85, 90, 95, or even 100) percent by number hollow fibers each have a hollow cross-sectional area in a range from 0.2 to 1 mm² (in some embodiments, in a range from 0.1 to 2, or even 0.1 to 5) mm².

For example, such hollow fiber webs as depicted in FIGS. 2 and 3 may be made by providing an extrusion die defining at least a first cavity, a second cavity, and a third cavity, and a dispensing surface. The dispensing surface has an array of alternating dispensing orifices. The extrusion die provides a fluid passageway between the second cavity and a second plurality of orifices, and the extrusion die provides a fluid passageway between the first cavity to a first plurality of orifices. The extrusion die also provides a third passageway extending from a third cavity to a third plurality of orifices and provides an open air passageway for the third cavity and the third dispensing orifices. The method further includes dispensing first hollow fibers from the first dispensing orifices while simultaneously dispensing spacer segments from the second dispensing orifices.

The size (same or different) of the hollow fiber be adjusted, for example, by the composition of the extruded polymers, velocity of the extruded hollow fibers, and/or the orifice design (e.g., cross-sectional area (e.g., height and/or width of the orifices)). Typically, the hollow fibers are extruded in the direction of gravity. In some embodiments, it is desirable to extrude the hollow fibers horizontally, especially when the extrusion orifices of the first and second polymer are not collinear with each other.

In practicing methods described herein, the polymeric materials might be solidified simply by cooling. This can be conveniently accomplished passively by ambient air, or actively by, for example, quenching the extruded first and second polymeric materials on a chilled surface (e.g., a chilled roll). In some embodiments, the first and/or second polymeric materials are low molecular weight polymers that need to be cross-linked to be solidified, which can be done, for example, by electromagnetic or particle radiation. In some embodiments, it is desirable to maximize the time to quenching to increase the weld strength.

Additional information that may be useful in making and using hollow fibers described therein (e.g., as depicted in FIGS. 2 and 3), when combined with the instant disclosure, can be found in U.S. Pat. Pub. No. 2014/0220328 and WO 2021/028798 (both to Ausen et al.), the disclosures of which are incorporated herein by reference in their entireties.

In some cases, the microporous hollow fiber web includes a netting comprising an array of polymeric strands, wherein the polymeric strands are periodically joined together at bond regions throughout the array with spaces between adjacent strands, wherein at least a portion of the strands are the connected hollow fibers each in a form of a hollow polymeric strand, and wherein at least 50 percent by number of the strands do not cross over each other. In some cases, at least a portion of the polymeric strands are solid strands and at least some of the solid strands comprise an open celled porous structure. Referring to FIG. 4, such a suitable hollow fiber web is in the form of a netting 400 comprising an array 401 of polymeric strands 402. Polymeric strands 402 are periodically joined together at bond regions 405 throughout the array 401 with spaces 403 between adjacent strands (i.e., between bond regions the bonded strands for each respective bond region are separated). At least a plurality (i.e., at least two) of the strands 402 are hollow polymeric strands (i.e., a hollow core 406 with a sheath 407 surrounding the hollow core). The strands 402 do not substantially cross over each other (i.e., at least 50 percent by number do not cross over each other). The netting 400 comprises openings 403. In some embodiments, the openings 403 are at least one of hexagonal-shaped or diamond shaped.

Strands made using methods described herein do not substantially cross over each other (i.e., at least 50 (at least 55, 60, 65, 70, 75, 80, 85, 90, 95, 99, or even 100) percent by number).

In some embodiments, the strands are within the same plane.

In some embodiments, a hollow strand alternates with a solid strand. The solid strand may be designed to provide uniform spacing of hollow strands. In some embodiments, a solid strand may be relatively small (e.g., 0.05 mm to 0.2 mm) or large (e.g., 0.2 mm to 2 mm) in diameter, and may have relatively short (e.g., 0.1 mm to 1 mm) or long (e.g., 1 mm to 10 mm) distances between bonds to facilitate desired spacing of hollow strands.

In some embodiments, the strands (i.e., the first strands and second strands), bond regions, and other optional strands, each have thicknesses that are substantially the same. In some embodiments, the bond regions have an average largest dimension perpendicular to the strand thickness, and wherein the average largest dimension of the bond regions is at least 2 (in some embodiments, at least 3, 4, 5, 10, or even at least 15) times greater than the average width of at least one of the first strands or the second strands.

In some embodiments, nettings described herein have a thickness up to 5,000 micrometers (in some embodiments, up to 2,000, 1,000, 500, 100, 50, or even up to 25: in a range from 10 to 5,000, 10 to 2,000, 10 to 1,000, 10 to 500, 10 to 100, 10 to 50, or even 10 to 25) micrometers.

In some embodiments, the polymeric strands have an average width in a range from 10 to 500 micrometers (in a range from 10 to 400, or even 10 to 250) micrometers. In some embodiments, the first polymeric strands have an average width in a range from 10 to 500 (in a range from 10 to 400, or even 10 to 250) micrometers; and the second strands have an average width in a range from 10 to 500 micrometers (in a range from 10 to 400, or even 10 to 250) micrometers.

In some embodiments, nettings described herein have a basis weight in a range from 5 to 1000 grams per square meter (g/m²) (in some embodiments, in a range from 10 to 400) g/m², for example, nettings as-made from dies described herein. In some embodiments, nettings described herein have a strand pitch in the machine direction, in a range from 0.5 to 20 mm (in some embodiments, in a range from 0.5 to 10) mm.

In some embodiments, at least 25 percent by number (in some embodiments, at least 30, 35, 40, 45, 50, 55, 60, 65, 70, 75, 80, 85, 90, 95, or even 100) percent by number hollow polymeric strands each have a hollow cross-sectional area in a range from 0.2 to 1 mm² (in some embodiments, in a range from 0.1 to 2, or even 0.1 to 5) mm².

Often, the solid strands comprise a first polymeric material and the hollow polymeric strands comprise a second polymeric material that is different from the first polymeric material.

For example, such hollow fiber webs as depicted in FIG. 4 may be made by providing an extrusion die defining at least a first cavity, a second cavity, and a third cavity, and a dispensing surface. The dispensing surface has an array of alternating dispensing orifices and the extrusion die provides a second passageway extending from the second cavity to a second plurality of orifices. The extrusion die also provides a third passageway extending from a third cavity to a third plurality of orifices and provides an open air passageway for the third cavity and the third dispensing orifices. The method further includes dispensing first polymeric strands from the first dispensing orifices at a first strand speed while simultaneously dispensing second polymeric strands from the second dispensing orifices at a second strand speed, wherein the first strand speed is at least 2 times the second strand speed, to provide a netting.

“Bond regions” as used herein refers to a line of demarcation between two strands bonded together. A demarcation line or boundary region can be detected using Differential Scanning calorimetry (DSC). Bonds are formed when two adjacent molten polymer strands collide with each other. Adjacent strands are extruded at alternating speeds such that adjacent molten strands continually collide, forming bonds, and then part, forming the net openings. Strands are extruded in the same direction, and thus, these bonds are parallel bonds, all formed in the same direction. The bonds are in the same plane, they do not cross over each other. For a given strand there is a first strand on one side which intermittently bonds, and a second strand on the opposite side which is also intermittently bonded. Bond regions are continuations of the two strands, and thus the bond region comprises the sum of the two adjacent strands. Typically, strands continue without disconnect and can be followed continuously through the bond regions.

The size (same or different) of the strands can be adjusted, for example, by the composition of the extruded polymers, velocity of the extruded strands, and/or the orifice design (e.g., cross sectional area (e.g., height and/or width of the orifices)). For example, a first polymer orifice that is 3 times greater in area than the second polymer orifice can generate a netting with equal strand sizes while meeting the velocity difference between adjacent strands.

In general, it has been observed that the rate of strand bonding is proportional to the extrusion speed of the faster strand. Further, it has been observed that this bonding rate can be increased, for example, by increasing the polymer flow rate for a given orifice size, or by decreasing the orifice area for a given polymer flow rate. It has also been observed that the distance between bonds (i.e., strand pitch) is inversely proportional to the rate of strand bonding, and proportional to the speed that the netting is drawn away from the die. Thus, it is believed that the bond pitch and the netting basis weight can be independently controlled by design of the orifice cross sectional area, the takeaway speed, and the extrusion rate of the polymer. For example, relatively high basis weight nettings, with a relatively short bond pitch can be made by extruding at a relatively high polymer flow rate, with a relatively low netting takeaway speed, using a die with a relatively small strand orifice area.

Typically, the polymeric strands are extruded in the direction of gravity. This enables collinear strands to collide with each other before becoming out of alignment with each other. In some embodiments, it is desirable to extrude the strands horizontally, especially when the extrusion orifices of the first and second polymer are not collinear with each other.

Additional information that may be useful in making and using nettings described therein, when combined with the instant disclosure, can be found in U.S. Pat. Pub. No. 2014/0220328 and WO 2020/170115 (both to Ausen et al.), the disclosures of which are incorporated herein by reference in their entireties.

As mentioned above, suitable hollow fiber webs may be produced by extrusion processes such as those described in PCT Publication Nos. WO 2020/170115, WO 2021/028798, and WO 2021/250478 (each to Ausen et al.). It is further noted that WO 2020/170115 discloses an option of stretching an as-made netting, which may orientate the strands and was observed to increase the tensile strength properties of the netting. Stretching may also reduce the overall strand size. Additionally, WO 2020/170115 discloses that if the materials and the degree of stretch are chosen correctly, the stretch can cause some of the strands to yield while others do not, tending to form loft. No stretching conditions were disclosed, however, nor any description of stretching that forms an open celled porous structure. Moreover, WO 2020/170115 teaches nettings that optionally contain a fluid in a core of the hollow strands (e.g., a gas, a liquid, or a viscous fluid), thus the presence of a porous structure in such hollow strands would allow the fluid to pass out of the core through the strand walls.

Methods of making microporous hollow fiber webs include obtaining a hollow fiber web comprising a plurality of connected hollow fibers, such as a hollow fiber web as described as suitable above, and stretching the hollow fiber web in a machine direction to fracture at least a portion of the hollow fibers to generate an open celled porous structure comprising microfibrils that connect lamellae microstructures in the fractured hollow fibers.

In select embodiments, the method further comprises annealing the hollow fiber web prior to stretching the hollow fiber web. Any annealing is performed at a temperature below a melting point of the polymeric material, for example, a hollow fiber web formed of PP is preferably annealed at 100-140° C. The annealing time could be from one second to hours: preferably 1-60 minutes: more preferably 5-30 minutes. One suitable stretching process includes, for example, stretching at ambient temperature followed by stretching at an elevated temperature, and then relaxation of the web.

Stretching can be advantageously performed using single or multi-stage cold stretching, optionally followed by single or multi-stage hot stretching. Preferably, the cold stretching temperature is selected to be between 5° C. and 70° C. above the glass transition temperature (T_{g}) of the polymer, more preferably between 10° C. to 50° C. (for example it is noted that the glass transition temperature of PP is −10° C. and PP is preferably stretched at 20° C. to 30° C.). Preferably, the hot stretching temperature is selected to be between 10° C. and 120° C. below the melt temperature of the polymer, more preferably between 20° C. to 60° C., for example PP is preferably stretched at 100° C. to 140° C.

A hollow fiber web may be advantageously stretched to form an open porous structure by uniaxial extension of at least 20%, and up to 500%, more preferably at least 50% and up to 300%.

A hollow fiber web after stretching may advantageously be exposed to a step of heat-setting to reduce the stress inside the individual fibers. The heat-setting temperature is typically selected to be higher than the hot stretching temperature by at least 5° C., at least 10° C., or even at least 15° C. The heating setting duration is typically selected to be at least 30 seconds, or at least one minute.

Alternatively, hollow fiber web after stretching may advantageously be exposed to a relaxation step by allowing fiber lengths to shrink to a certain extent, which is at least 2%, or even at least 5%. Heating setting and relaxation can be used alone or combination.

Unexpectedly, good fiber porosity has been achieved by such “dry” stretching of a nonporous hollow fiber web. The hollow fibers having an open celled porous structure typically exhibit a porosity of 5 volume percent (vol %) or greater, 10 vol %, 12 vol %, 15 vol %, 17 vol %, 20 vol %, 25 vol %, 30 vol %, 35 vol %, 40 vol %, 45 vol %, or 50 vol %; and 80 vol % or less, 75 vol %, 70 vol %, 65 vol %, 60 vol %, 55 vol %, or 50 vol % or less. The porosity advantageously imparts at least one of improved (e.g., fluid) absorbency, filtration properties, gas separation properties, insulation properties, or functionalization capability.

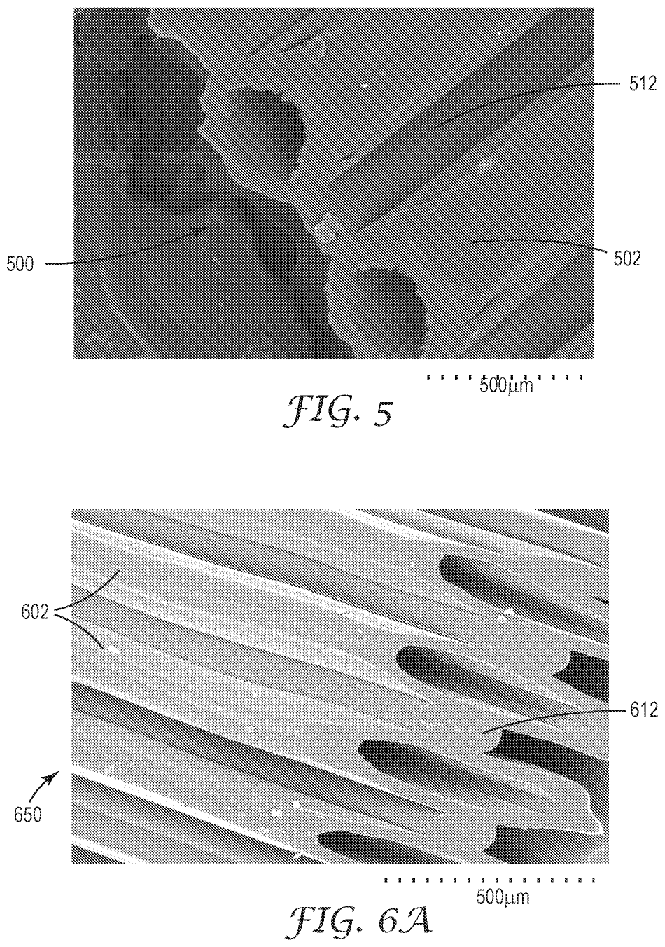

Referring to FIG. 5, a scanning electron microscopy (SEM) image of a cross-section of a portion of an exemplary microporous hollow fiber web 500, prepared according to Example 1 described below. Adjacent hollow fibers 502 and spacer segments 512 of the web 500 are visible.

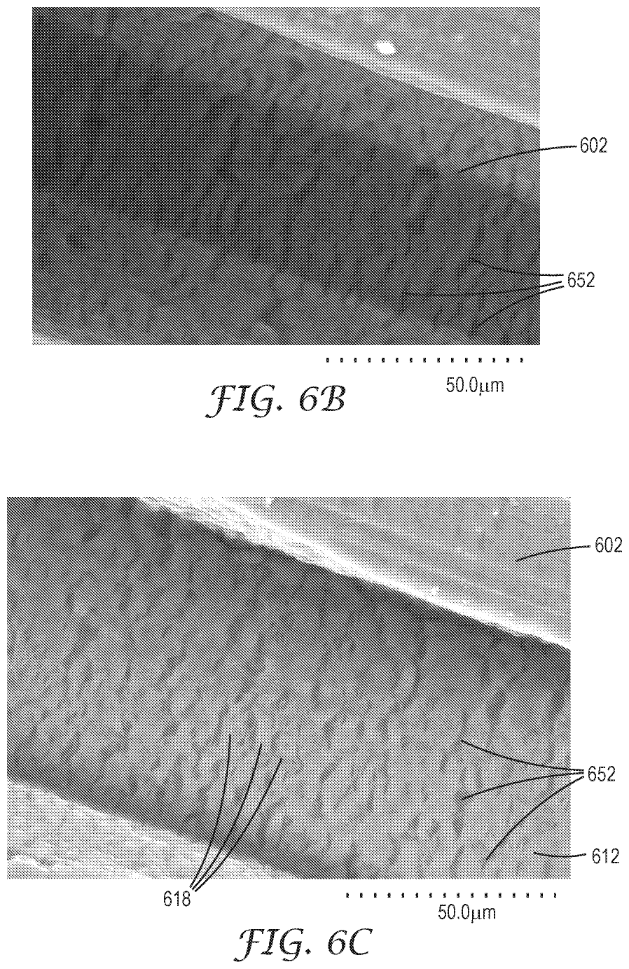

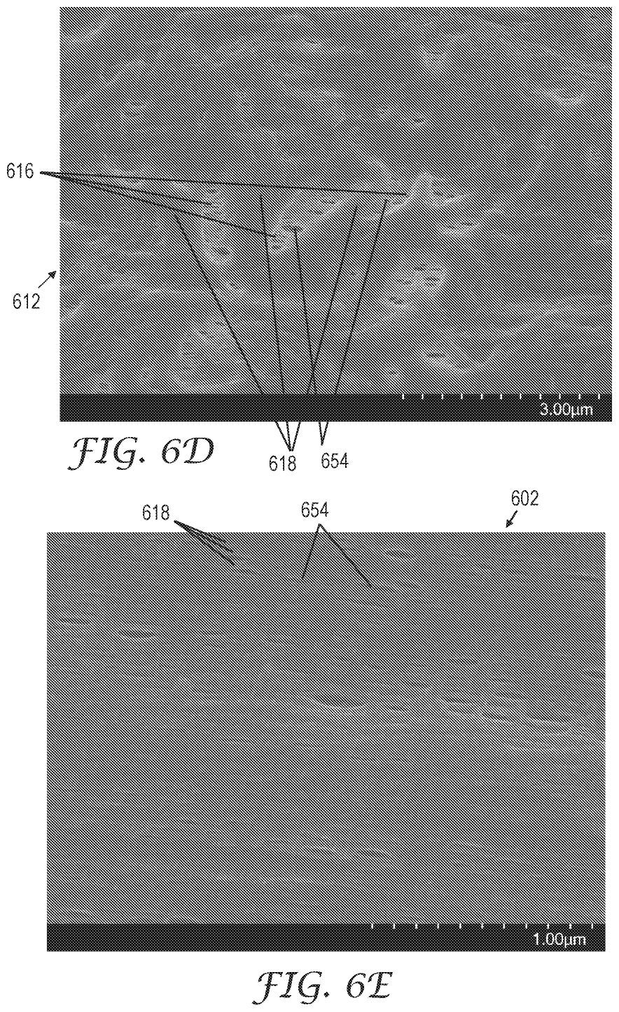

Referring now to FIG. 6A, an SEM image of a cross-section of a portion of an exemplary microporous hollow fiber web 650 is provided. The microporous hollow fiber web 650 comprises hollow fibers 602 connected by spacer segments 612. FIG. 6B is an SEM image of a portion of an interior surface of one hollow fiber 602 in which the open celled porous structure 652 is more visible due to the greater magnification than provided in FIG. 6A.

Similarly, FIG. 6C is an SEM image of a portion of one spacer segment 612 in which the open celled porous structure 652 is more visible due to the greater magnification than provided in FIG. 6A. This exemplary microporous hollow fiber web comprises row-ordered lamella microstructures 618. As visible in FIG. 6C, the lamellae are not present in perfectly parallel rows but rather overall form adjacent rows.

Referring to FIG. 6D, the open celled porous structure comprising microfibrils that connect lamellae microstructures is visible. FIG. 6D is an SEM image that shows a surface of a spacer segment 612 that includes a plurality of microfibrils 616 extending between opposing lamellae microstructures 618. The microfibrils 616 and lamella microstructures 618 together define voids 654 of the open celled porous structure of the hollow fiber 602. The size of the microfibrils 616 can vary, as evident in FIG. 6D, typically including at least one dimension that has a length of 1 micrometer or smaller. This exemplary microporous hollow fiber web has more curved row-ordered lamella microstructures 618. As visible in FIG. 6D, the lamellae are not overall form adjacent rows attached by microfibrils 616. It is noted that in some cases an exterior surface (e.g., skin) of a hollow fiber may not be as oriented from the extrusion process as deeper into the wall of the hollow fiber due to the quenching environment, which would result in the lamellae being not as oriented at the surface as they are deeper into the wall.

Referring to FIG. 6E, the open celled porous structure of an interior surface of a hollow fiber 602 is visible. Row-ordered lamellae microstructures 618 are visible between voids 654 (but the microfibrils are not).

It is clear from each of FIGS. 6B-6E that the open celled porous structure lacks filler particles present at least partially in the voids 654 of the porous structure. This is in direct contrast to some prior methods for forming porous structure in fibers by including additives such as filler material (e.g., particulate fillers and nanoinclusion additives), for instance as described in U.S. Pat. No. 5,766,760 (Tsai et al.) and U.S. Pat. No. 11,001,944 (Topolkaraev et al.), respectively. Although a filler may be a suitable optional additive to include in microporous hollow fiber webs according to some embodiments of the present disclosure, such fillers do not significantly contribute to pore formation. This is evidenced at least by less than 20% of the total open celled pores of a fiber comprising a filler visible in the void, less than 15%, less than 10%, or less than 5% of the total open celled pores of a hollow fiber comprising a filler visible in the void.

### EXEMPLARY EMBODIMENTS

In a first embodiment, the present disclosure provides a microporous hollow fiber web. The microporous hollow fiber web comprises a plurality of connected hollow fibers. At least some of the hollow fibers comprise an open celled porous structure comprising microfibrils that connect lamellae microstructures.

In a second embodiment, the present disclosure provides a microporous hollow fiber web according to the first embodiment, comprising an array of the connected hollow fibers each in a form of a discrete hollow fiber. Adjacent hollow fibers are connected at bond regions and the web is a continuous web.

In a third embodiment, the present disclosure provides a microporous hollow fiber web according to the first embodiment, comprising an array of the connected hollow fibers each in a form of a discrete hollow fiber; and a plurality of spacer segments between at least a plurality of adjacent hollow fibers. The hollow fibers are within one or more planes and the web is a continuous web.

In a fourth embodiment, the present disclosure provides a microporous hollow fiber web according to the third embodiment, wherein at least some of the spacer segments comprise an open celled porous structure.

In a fifth embodiment, the present disclosure provides a microporous hollow fiber web according to the first embodiment, comprising a netting comprising an array of polymeric strands. The polymeric strands are periodically joined together at bond regions throughout the array with spaces between adjacent strands, at least a portion of the strands are the connected hollow fibers each in a form of a hollow polymeric strand, and at least 50 percent by number of the strands do not cross over each other.

In a sixth embodiment, the present disclosure provides a microporous hollow fiber web according to the fifth embodiment, wherein at least a portion of the polymeric strands are solid strands and at least some of the solid strands comprise an open celled porous structure.

In a seventh embodiment, the present disclosure provides a microporous hollow fiber web according to the sixth embodiment, wherein the solid strands comprise a first polymeric material and the hollow polymeric strands comprise a second polymeric material that is different from the first polymeric material.

In an eighth embodiment, the present disclosure provides a microporous hollow fiber web according to any of the first through seventh embodiments, wherein the hollow fibers comprise one or more semicrystalline polymers.

In a ninth embodiment, the present disclosure provides a microporous hollow fiber web according to any of the first through eighth embodiments, wherein the hollow fibers comprise at least one of a polypropylene (PP), a polyethylene (PE), a polymethyl pentene (PMP), a poly butene-1, a polyoxymethylene (POM), or copolymers thereof.

In a tenth embodiment, the present disclosure provides a microporous hollow fiber web according to any of the first through ninth embodiments, wherein the hollow fibers comprise a PP.

In an eleventh embodiment, the present disclosure provides a microporous hollow fiber web according to any of the first through tenth embodiments, wherein the hollow fibers comprise a blend of at least two semicrystalline polymers.

In a twelfth embodiment, the present disclosure provides a microporous hollow fiber web according to any of the first through eleventh embodiments, wherein the hollow fibers exhibit a porosity of 5 volume percent to 80 volume percent.

In a thirteenth embodiment, the present disclosure provides a method of making a microporous hollow fiber web. The method comprises obtaining a hollow fiber web comprising a plurality of connected hollow fibers; and stretching the hollow fiber web in a machine direction to fracture at least a portion of the hollow fibers to generate an open celled porous structure comprising microfibrils that connect lamellae microstructures in the fractured hollow fibers.

In a fourteenth embodiment, the present disclosure provides a method of making a microporous hollow fiber web according to the thirteenth embodiment, further comprising annealing the microporous hollow fiber web prior to stretching the hollow fiber web.

In a fifteenth embodiment, the present disclosure provides a method of making a microporous hollow fiber web according to the thirteenth embodiment or the fourteenth embodiment, wherein obtaining the hollow fiber web comprises providing an extrusion die defining at least a first cavity, and a second cavity, and a dispensing surface. The dispensing surface has an array of alternating dispensing orifices, the extrusion die provides a first passageway extending from the first cavity to a first plurality of orifices, and the extrusion die provides a second passageway extending from a second cavity to a second plurality of orifices. Obtaining the hollow fiber web further comprises dispensing first hollow fibers from the first dispensing orifices and providing an open air passageway for the second cavity and the second dispensing orifices.

In a sixteenth embodiment, the present disclosure provides a method of making a microporous hollow fiber web according to the thirteenth embodiment or the fourteenth embodiment, wherein obtaining the hollow fiber web comprises providing an extrusion die defining at least a first cavity, a second cavity, and a third cavity, and a dispensing surface. The dispensing surface has an array of alternating dispensing orifices, the extrusion die provides a second passageway extending from the second cavity to a second plurality of orifices, and the extrusion die provides a third passageway extending from a third cavity to a third plurality of orifices. Obtaining the hollow fiber web further comprises dispensing first polymeric strands from the first dispensing orifices at a first strand speed while simultaneously dispensing second polymeric strands from the second dispensing orifices at a second strand speed, and providing an open air passageway for the third cavity and the third dispensing orifices. The first strand speed is at least 2 times the second strand speed to provide a netting.

In a seventeenth embodiment, the present disclosure provides a method of making a microporous hollow fiber web according to the thirteenth embodiment or the fourteenth embodiment, wherein obtaining the hollow fiber web comprises providing an extrusion die defining at least a first cavity, a second cavity, and a third cavity, and a dispensing surface. The dispensing surface has an array of alternating dispensing orifices, the extrusion die provides a fluid passageway between the second cavity and a second plurality of orifices, the extrusion die provides a fluid passageway between the first cavity to a first plurality of orifices, and the extrusion die provides a third passageway extending from a third cavity to a third plurality of orifices. Obtaining the hollow fiber web further comprises dispensing first hollow fibers from the first dispensing orifices while simultaneously dispensing spacer segments from the second dispensing orifices and providing an open air passageway for the third cavity and the third dispensing orifices.

### EXAMPLES

Objects and advantages of this disclosure are further illustrated by the following examples, but the particular materials and amounts thereof recited in these examples, as well as other conditions and details, should not be construed to unduly limit this disclosure. Unless otherwise noted or otherwise apparent from the context, all parts, percentages, ratios, etc. in the Examples and the rest of the specification are by weight.

A hollow fiber web precursor with 6 hollow fibers was prepared as follows: hollow fibers and spacer segments were extruded using a single screw extruder out of polypropylene resin (obtained from Braskem America, Inc., Philadelphia, PA, under trade designation “FF030F2”). The temperature was set at 177-220° C. and melt flow rate was about 2.6 lbs/hr (1.18 kg/hr). The melt was fed into two series of melt cavities in a web spinning die. The die temperature was set at 220° C. The melt cavities for hollow fiber web precursor had annular orifices and one center hole for core air supply. The other series of cavities formed spacer segments to bond adjacent hollow fiber precursors together. The hollow fiber web precursors were quenched by an air knife. The web precursors in their molten state were drawn down by three sets of godet rolls at a drawing speed of 100 meters per minute.

A microporous hollow fiber web was prepared from the hollow fiber web precursors by annealing followed by dry stretching. The hollow fiber web precursor was annealed in a convection oven set at a temperature at 140° C. for 20 min. For dry (cold/hot) stretching, the precursor sample was clamped in a temperature-controlled environmental chamber of an Instron Mechanical Tester (Model 5969, obtained from Instron Corporation, Norwood, MA). A 127 mm (5 inch) long web was cold stretched at a stretching rate 600 mm/minute at 25° C. and subsequently hot-stretched with stretching rate 100 mm/min at 120° C. Total extension ratios after 10% relaxation was 100%.

FIG. 5 shows an SEM of a portion of the resulting microporous hollow fiber web. CO₂ flow rate (GPU) of the resulting microporous hollow fiber web was measured using a custom designed test stand. The stand was equipped with cylinders of pure CO₂ gas, pressure gauges, and in-line gas flow meters. The principle of this testing was to supply a pure gas into a microporous hollow fiber lumen and to measure the rate of the gas flowing through fiber walls into ambient environment. Both the gas pressure and the gas flow rate were monitored by data acquisition software, and data were acquired when both the pressure and gas flow rate were stabilized.

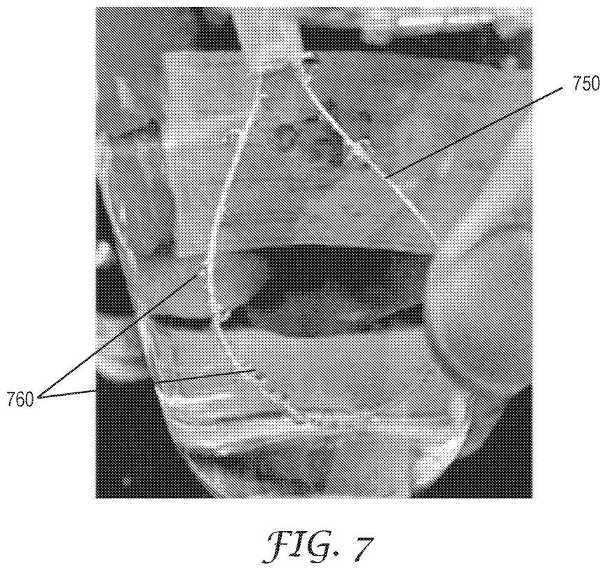

Three loop module replicates were prepared by sealing a microporous hollow fiber web together in a 0.65 cm (¼ inch) OD nylon tube with an epoxy adhesive. The lumen of each fiber was exposed by cutting the sealing tube with a razor blade. The loop module contained the microporous hollow fiber web with about 10.2 cm (4 inch) effective lengths. Referring now to FIG. 7, a photograph is provided of an exemplary microporous hollow fiber web 750 subjected to the gas flux test. Air bubbles 760 are visible in the photograph, indicating that the hollow fiber web 750 is indeed microporous. The gas permeation rate (GPU, 1 GPU=10⁻⁶ cm³ (STP)/(cm²·s·cm Hg)) of microporous hollow fiber web was calculated as follows:

$$Gas permeation ( GPU ) = \frac{Q}{Δ P * A} * 1 {0}^{6}$$

wherein: Q is the gas flow rate (scc/sec);
   ΔP is the gas pressure differential reading (cm Hg); and
   A is the fiber outer surface area (cm²)
      The fiber surface area was calculated from its OD (150 micrometer) measured using the SEM of FIG. 5. Note that when the modules were inserted into a water reservoir, gas bubbles caused by gas flowing through fiber walls were visible along the hollow fiber web. This suggests that hollow fibers in the web had open celled, porous walls. Furthermore, the porous structure of both the spacer segment and interior surface of hollow fibers can be clearly seen under the higher resolution SEM images of FIGS. 6A-6E.

The hollow fiber web module prepared as described above had a CO₂ flow rate (i.e., flux) of 156+/−70 GPU.

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A microporous hollow fiber web comprising a plurality of connected hollow fibers, wherein at least some of the hollow fibers comprise an open celled porous structure comprising microfibrils that connect lamellae microstructures.

2. The microporous hollow fiber web of claim 1, comprising:
an array of the connected hollow fibers each in a form of a discrete hollow fiber;
wherein adjacent hollow fibers are connected at bond regions, and wherein the web is a continuous web.

3. The microporous hollow fiber web of claim 1, comprising:
an array of the connected hollow fibers each in a form of a discrete hollow fiber; and
a plurality of spacer segments between at least a plurality of adjacent hollow fibers;
wherein the hollow fibers are within one or more planes and wherein the web is a continuous web.

4. The microporous hollow fiber web of claim 3, wherein at least some of the spacer segments comprise an open celled porous structure.

5. The microporous hollow fiber web of claim 1, comprising:
a netting comprising an array of polymeric strands, wherein the polymeric strands are periodically joined together at bond regions throughout the array with spaces between adjacent strands, wherein at least a portion of the strands are the connected hollow fibers each in a form of a hollow polymeric strand, and wherein at least 50 percent by number of the strands do not cross over each other.

6. The microporous hollow fiber web of claim 5, wherein at least a portion of the polymeric strands are solid strands and at least some of the solid strands comprise an open celled porous structure.

7. The microporous hollow fiber web of claim 6, wherein the solid strands comprise a first polymeric material and the hollow polymeric strands comprise a second polymeric material that is different from the first polymeric material.

8. The microporous hollow fiber web of claim 1, wherein the hollow fibers comprise one or more semicrystalline polymers.

9. The microporous hollow fiber web of claim 1, wherein the hollow fibers comprise at least one of a polypropylene (PP), a polyethylene (PE), a polymethyl pentene (PMP), a polybutene-1, a polyoxymethylene (POM), or copolymers thereof.

10. The microporous hollow fiber web of claim 1, wherein the hollow fibers comprise a PP.

11. The microporous hollow fiber web of claim 1, wherein the hollow fibers comprise a blend of at least two semicrystalline polymers.

12. The microporous hollow fiber web of claim 1, wherein the hollow fibers exhibit a porosity of 5 volume percent to 80 volume percent.

13. A method of making a microporous hollow fiber web, the method comprising:
obtaining a hollow fiber web comprising a plurality of connected hollow fibers; and
stretching the hollow fiber web in a machine direction to fracture at least a portion of the hollow fibers to generate an open celled porous structure comprising microfibrils that connect lamellae microstructures in the fractured hollow fibers.

14. The method of claim 13, further comprising annealing the microporous hollow fiber web prior to stretching the hollow fiber web.

15. The method of claim 13, wherein obtaining the hollow fiber web comprises:
providing an extrusion die defining at least a first cavity, and a second cavity, and a dispensing surface, wherein the dispensing surface has an array of alternating dispensing orifices, wherein the extrusion die provides a first passageway extending from the first cavity to a first plurality of orifices, and the extrusion die provides a second passageway extending from a second cavity to a second plurality of orifices; and
dispensing first hollow fibers from the first dispensing orifices and providing an open air passageway for the second cavity and the second dispensing orifices.

16. The method of claim 13, wherein obtaining the hollow fiber web comprises:
providing an extrusion die defining at least a first cavity, a second cavity, and a third cavity, and a dispensing surface, wherein the dispensing surface has an array of alternating dispensing orifices, wherein the extrusion die provides a second passageway extending from the second cavity to a second plurality of orifices, and the extrusion die provides a third passageway extending from a third cavity to a third plurality of orifices; and
dispensing first polymeric strands from the first dispensing orifices at a first strand speed while simultaneously dispensing second polymeric strands from the second dispensing orifices at a second strand speed, and providing an open air passageway for the third cavity and the third dispensing orifices, wherein the first strand speed is at least 2 times the second strand speed to provide a netting.

17. The method of claim 13, wherein obtaining the hollow fiber web comprises:
providing an extrusion die defining at least a first cavity, a second cavity, and a third cavity, and a dispensing surface, wherein the dispensing surface has an array of alternating dispensing orifices, wherein the extrusion die provides a fluid passageway between the second cavity and a second plurality of orifices, the extrusion die provides a fluid passageway between the first cavity to a first plurality of orifices, and the extrusion die provides a third passageway extending from a third cavity to a third plurality of orifices; and
dispensing first hollow fibers from the first dispensing orifices while simultaneously dispensing spacer segments from the second dispensing orifices and providing an open air passageway for the third cavity and the third dispensing orifices.
